(19) United States
(12) Patent Application Publication
(10) Pub. No.: US 2009/0250076 A1
(43) Pub. Date: Oct. 8, 2009

(54) Dental Floss and Method of Making Same

(76) Inventors: John William Dolan, Centreville, DE (US); Debra Lynne Raup, Havre de Grace, MD (US); James Patrick Sullivan, Lincoln University, PA (US)

Correspondence Address: Dianne Burkhard;W. L. Gore & Associates, Inc., 551 Paper Mill Road, Newark, DE, 19714-9206, US

(21) Appl. No.: 12/487,087

(22) Filed: Jun. 18, 2009

Related U.S. Application Data
(63) Continuation of application No. 11/366,886, filed on Mar. 1, 2006, now abandoned.

(51) Int. Cl. A61C 15/04; B05D 3/02

(52) U.S. Cl. 132/321; 427/2.29

(57) ABSTRACT

Unique dental floss article comprising islands attached to the underlying surface of dental floss for dislodging plaque and oral debris during use. These unique structures exhibit superior retention of the drag resistance during flossing.

### CROSS REFERENCE TO RELATED APPLICATIONS

This application is a continuation of commonly owned and co-pending U.S. application Ser. No. 11/366,886, filed Mar. 1, 2006.

### FIELD OF THE INVENTION

The present invention relates to an improved form of dental floss and dental tape. Further novel structures and dental floss surfaces for improved cleaning and user perception of efficacy are discussed.

### BACKGROUND OF THE INVENTION

Dental floss and dental tape are used to remove plaque and oral debris between dental contacts and within the subgingival tissue. Materials such as nylon, PTFE, polyester, silk, polypropylene, ultra high molecular weight polyethylene are used for dental floss. A preferred material is PTFE and in particular, expanded forms of PTFE (known as “ePTFE”), due to the high lubricity which results in lower force required to insert the floss between tight contacts. Another desired property of ePTFE is high break strength which reduces floss breakage during flossing.

Disadvantageously, the typically smooth surface on ePTFE floss may not give the user the perception that the floss is cleaning during a flossing episode or provide edges on its surface to capture plaque and oral debris. One solution is to fill the floss with particles, however, they may become dislodged during flossing and may be transferred to the oral cavity.

The structure of ePTFE is well known to be characterized by nodes interconnected by fibrils, as taught in U.S. Pat. Nos. 3,953,566 and 4,187,390, to Gore, and which patents have been the foundation for a significant body of work directed to ePTFE materials and filled forms of ePTFE. The node and fibril character of the ePTFE structure has been modified in many ways since it was first described in these patents. For example, highly expanded materials, as in the case of high strength fibers, can exhibit exceedingly long fibrils and relatively small nodes. Other process conditions can yield articles, for example, with nodes that extend through the thickness of the article.

The structure of ePTFE may also be modified by surface treatment. Surface treatment of ePTFE structure has been carried out by a variety of techniques in order to modify the ePTFE structure. Okita (U.S. Pat. No. 4,208,745) teaches exposing the outer surface of an ePTFE tube, specifically a vascular prosthesis, to a more severe (i.e., higher) thermal treatment than the inner surface in order to effect a finer structure on the inside than on the outside of the tube. Zukowski (U.S. Pat. No. 5,462,781) teaches employing plasma treatment to effect removal of fibrils from the surface of porous ePTFE in order to achieve a structure with freestanding nodes on the surface which are not interconnected by fibrils. Martakos et al. (U.S. Pat. No. 6,573,311) teach plasma glow discharge treatment, which includes plasma etching, of polymer articles at various stages during the polymer resin processing. The focus of Martakos et al. is to affect bulk properties such as porosity and/or chemistry quality in the finished articles.

In a further example, Campbell et al (U.S. Pat. No. 5,747,128) teach a means of creating regions of high and low bulk density throughout a porous PTFE article. Additionally, Kowligi et al. (U.S. Pat. No. 5,466,509) teach impressing a pattern onto an ePTFE surface, and Seiler et al. (U.S. Pat. No. 4,647,416) teach the scoring PTFE tubes during fabrication in order to create external ribs.

U.S. Pat. No. 6,112,753 to Arsenault teaches a floss having protuberances. The protuberances defined by Arsenault are large when viewed in the context of the expected use of a floss in tight contacts. The preferred size of Arsenault's protuberances is at least 2× the diameter of the floss. Further, Arsenault is directed to floss having a circular cross-section, and does not consider the class of dental floss known as monofilaments. Where the protuberance diameter is at least twice the floss' diameter, then only one protuberance may exist in any transverse segment of floss since the protuberance consumes the entire transverse width (region) of the base floss. The resulting thickness in the areas of the protuberances may cause significant difficulty in inserting the floss into tight contacts, i.e. between teeth.

U.S. Pat. No. 6,132,445 to Pavenelli describes a device to clean the tongue and oral cavity. The device contains protuberances which are round in shape and are used to help to scrap the tongue. However, the user can not floss between teeth with this device and the user can not perform the ADA recommended “C” wrap around the user's tooth during use thus making the device unsuitable as a floss.

Providing a dental device which is rough is disclosed in U.S. Pat. Nos. 5,819,767 to Dix; 5,476,382 to Dragen; 5,769,103 to Turjak; 6,158,444 to Weihrauch; and 6,168,241 to Zapanta. None disclose a dental floss with which a user can perform the ADA recommended “C” wrap around the user's teeth and therefore unsuitable as floss.

The concept of roughening the surface of a floss is also known. U.S. Pat. No. 5,819,767 refers to reference which teaches floss being rough or crimped. However, the floss does not provide sufficient grip when a floss is tensioned in the ring holder described. The roughness is defined as gripping power for restraining a floss in a ring holder device. The floss is not a continuous length but rather, short pieces, less than 5 cm and placed in a ring holder. U.S. Pat. No. 5,476,382 refers to an interproximal dental disk which is rough. U.S. Pat. No. 5,769,103 is directed to a flat interdental space cleaner having a resilient strip which may be rough. Another patent which discloses the concept of roughness is U.S. Pat. No. 6,158,444 which discloses an interdental cleaner device. This device is made up of at least two components and is a segment as opposed to a continuous length of floss.

The concept of roughening the surface of the dental floss in a manner which is effective for both improved cleaning efficacy and for improved cleaning perception is not taught in the heretofore mentioned references. Moreover, none teach the unique processes described herein to create a unique surface on dental floss and dental tape which has heretofore not been seen.

### SUMMARY OF THE INVENTION

The present invention is directed to a polymeric dental floss that has improved cleaning efficacy and improved perception for cleaning during use. Floss structures of the present invention may comprise various polymeric materials such as ultrahigh molecular weight polyethylene (UHMWPE), polyimide, or polytetrafluoroethylene (PTFE). The floss material such as ePTFE material may or may not have been exposed to amorphous locking temperatures. The present invention is related to the floss's unique surface structure comprising islands attached to the underlying structure and to methods of making such a structure.

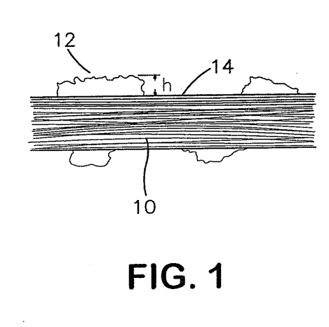

The unique structures of the present invention exhibit islands attached to and raised above the primary floss surface. By “raised” is meant that when the article is viewed in cross-section, such as in a photomicrograph of the article cross-section, the islands are seen to rise above the baseline defined by the outer surface of the underlying primary floss structure. For example, where the primary floss structure is expanded PTFE (ePTFE), island structures are raised when compared to the node-fibril structure of the primary floss structure by a height, “h.” Referring to FIG. 1, which shows a cross-section of a floss 10 with islands 12, the height of the island 12 rises a height “h” above the surface 14, or “baseline,” of the primary floss structure, e.g. the underlying ePTFE structure.

These raised regions, or islands, are connected at their bases to the underlying floss structure. In preferred structures, islands are bonded to the primary floss structure, such as by melt bonding. Where the primary floss is porous, the islands may penetrate the surface of the primary floss, thus additionally being partially present below the surface of the primary floss. In the case of a primary floss structure made of ePTFE, the islands are distinguishable from the underlying nodes and fibrils because of their much larger size. The largest length dimension of the islands is at least twice that of the same dimension of the underlying nodes. This length difference can even exceed 100 times that of the underlying nodes. Further, the morphology of the islands tends to distinguish them from the underlying ePTFE structure. Where the primary flow structure is non-porous, the island structures comprised of, for example, fluorinated ethylene-propylene resin (FEP) or UHMWPE are unique to the surface of the primary floss structure and are not present below the surface.

The morphology of the floss structures of the present invention may also vary widely with respect to the number of islands present on a given primary floss surface area. In many cases, the islands are large and not interconnected. In other embodiments, the islands are interconnected and may appear as a porous covering or web atop the primary floss structure.

In one embodiment of the present invention, a dental floss is provided comprising a non-fluoropolymer, such as UHMWPE, as a primary floss structure and further comprises the aforementioned islands made of a material such as UHMWPE; for enhanced cleaning and cleaning perception, the islands are randomly positioned extending beyond the surface of the underlying primary floss surface.

In another embodiment of the present invention a dental floss comprising polyimide as the primary floss structure comprises the aforementioned islands made of a material such as FEP for enhanced cleaning and cleaning perception.

The unique character of the present articles and processes enable the formation of improved products not seen to date. For example, fibers can be made according to invention having improved performance in such areas as dental floss, fishing line, sutures, and the like. Articles in membrane, tube, sheet and other forms can also provide unique characteristics in finished products. These and other unique features of the present invention will be described in more detail herein.

### DETAILED DESCRIPTION OF FIGURES

The operation of the present invention should become apparent from the following description when considered in conjunction with the accompanying drawings, in which:

FIG. 1 is perspective view of a cross-section of a fiber in accordance with the present invention showing islands above the surface of an underlying primary floss structure.

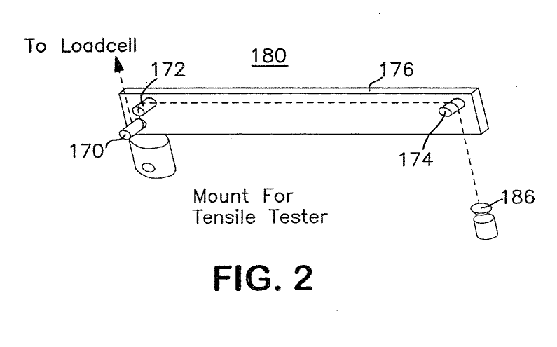

FIG. 2 is perspective view of a fixture set-up for measuring mechanical properties of materials of the present invention as described in more detail herein.

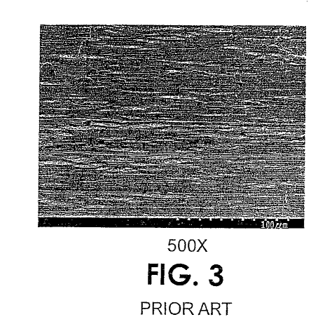

FIG. 3 is a photomicrograph showing the surface of the precursor material used in Example 2.

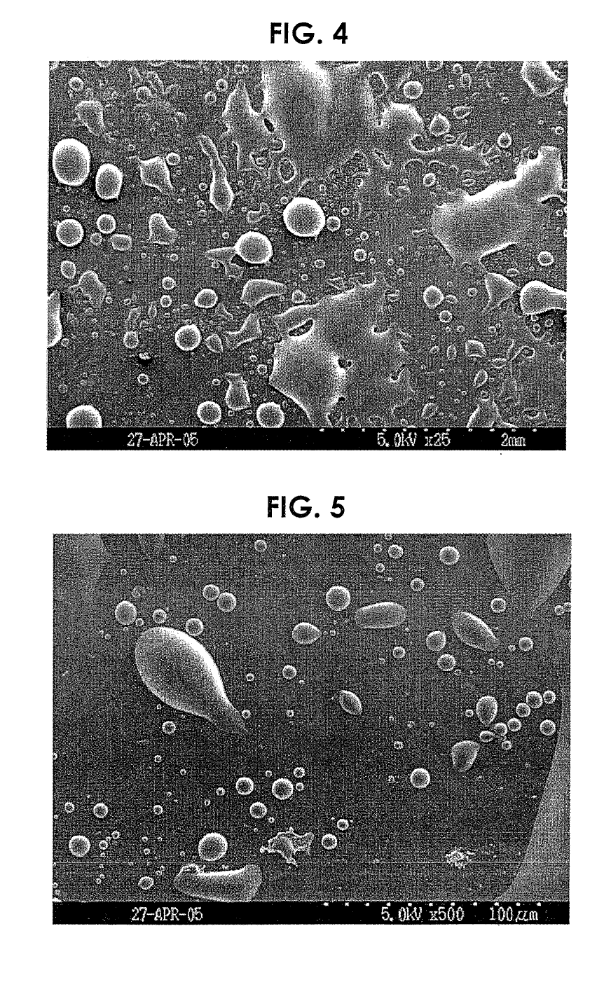

FIGS. 4, 5, and 6 are photomicrographs of the inventive material made in accordance with Example 1.

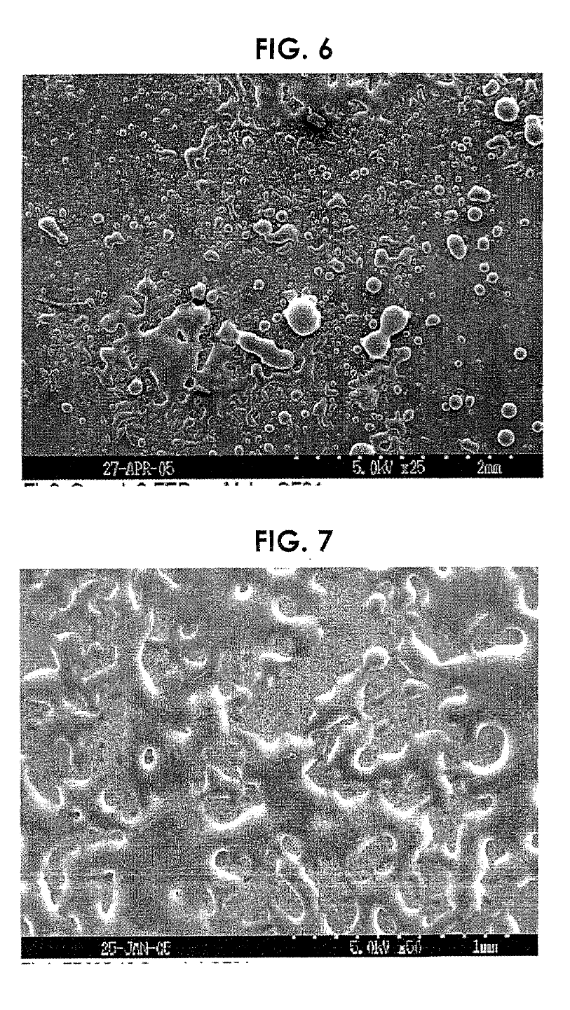

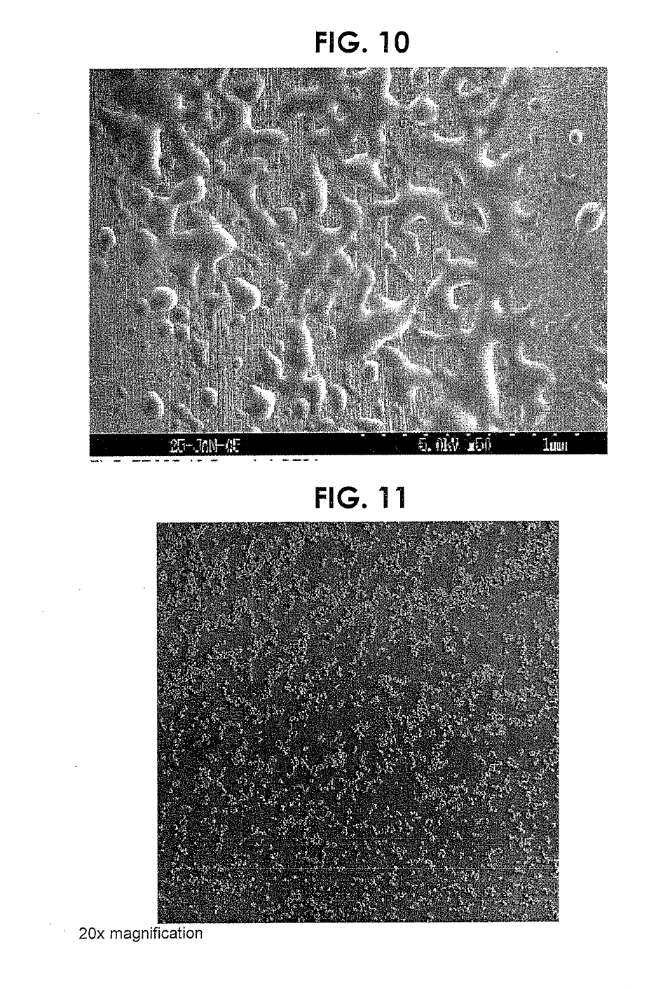

FIGS. 7, 8, 9, and 10 are photomicrographs of the inventive material made in accordance with Example 2.

FIGS. 11, 12, and 13 are photomicrographs of the inventive material made in accordance with Example 3.

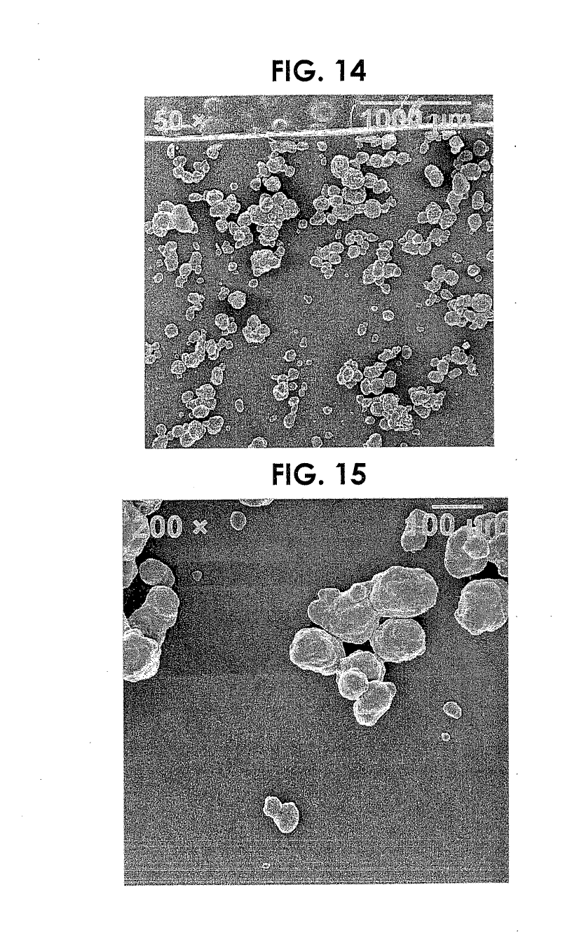

FIGS. 14 and 15 are photomicrographs of the inventive material made in accordance with Example 4 at magnifications 50× and 200×.

### DETAILED DESCRIPTION OF THE INVENTION

The present invention is directed to a dental floss structure that comprises islands of polymer material attached to an underlying, primary polymer structure. Specifically, the present invention is directed to a dental floss comprising a primary floss structure comprised of a polymer, and islands attached to the surface of the polymer substrate. Preferred primary floss structures comprise polymers such as PTFE, UHMWPE, polyamide and polyimide. Islands may be comprised of the same or different materials as the primary structure, and are preferably selected from polyethylene (PE), UHMWPE polyamide, polyimide, and FEP.

The material forming the islands may be applied to the primary floss structure in any way suitable for applying a powder or a dispersion to the surface of a polymer substrate. For example, in one preferred embodiment where the islands are made from UHMWPE powder, the powder is sprinkled on to the surface of the primary floss structure. In another embodiment, an island precursor material may be applied as a dispersion to the surface of the primary floss substrate.

In one embodiment of the present invention, a primary floss structure having an island precursor material applied thereto is heated to a temperature above the melt point of the island precursor material. The material is cooled, and islands are bonded to the surface of the primary floss structure.

In one embodiment of the present invention, a floss has at least 2 or more islands on the floss' width thereby providing increased edges for surface cleaning and removal of dental debris including plaque in the preferred transverse motion for proper floss technique.

For purposes of the present invention, height and spacing measurements of islands on the primary floss structure are determined by profilometry methods described herein. Preferred articles of the present invention will be prepared wherein about 85% of island peaks have a height of from about 5 to 100 μm, or about 5 to 80 μm, more preferably from about 10 to 37 μm. When measured according to the method described herein, it is most preferred that the average space between islands, as measured by the test described herein, is less than about 250 μm, less than about 150 μm, more preferably less than about 75 μm. Where the present invention is directed to a dental floss having enhanced grippability or perceived effectiveness, preferred flosses have peak spacing less than about 75 μm, or less than about 45 μm.

Articles of the present invention possess surprising and valuable features heretofore unobtainable. The dental floss materials are found to have significantly increased grippabililty and abrasive characteristics. Grippability refers to the ability to firmly grip the floss during use such that it does not slide between the user's fingers. The abrasiveness provides the user with an improved cleaning sensation, if not with improved cleaning, as well. These characteristics have not been realized to this degree in conventional PTFE floss or other monofilament floss such as UHMWPE, polyester, or polypropylene materials.

Articles of the invention can exhibit increased abrasiveness evidenced by an increased drag resistance. Surprisingly, the abrasion or drag resistance does not decrease with repeated use of the same area of the floss as is found in traditional coated flosses such as wax coated PTFE. The present invention exhibits minimal degradation to its abrasion quality or, as measured herein, drag resistance, because the surface modification is more permanently attached to the surface of the floss. Coatings on traditional floss such as wax, namely natural and synthetic waxes easily are removed during floss use. Likewise, abrasive materials included in coatings, such as wax coatings, are not readily attached to the floss surface and degradation of drag resistance occurs. Therefore, preferred flosses of the present invention have a drag resistance decay of less than 30%, 25%, or 20%, when tested according to the method described herein having five repeated passes.

Dental floss and dental tape made from primary floss structures comprising polymers, such as PTFE, UHMWPE and polyimide, and which contain “islands” have shown to offer the user an improved cleaning enhancement or perception as well. The improved dental floss contains a non-directional pattern or array of islands over the width and down the length of the floss. Moreover, the individual islands are preferably random in size and non-patterned such to provide the user a random vibrational feel during use. Additionally, a random pattern may provide the user an improved cleaning surface in any flossing direction. In contrast, where islands are in a pattern which is directional, benefit from the cleaning and tactile feel of the islands may depend on the direction in which the floss is moved. Dental floss of the present invention may optionally be coated or filled or imbibed with at least one or more of flavor, color, flavor enhancer, sweetener, natural wax, synthetic wax, hydrocarbon based wax, micro crystalline wax, beeswax, medicament, abrasive, grip enhancing media, enzyme, vitamin, bio-active agents, recalcification agents, micro-sphere, coagulant and analgesic. The floss may optionally contain a water soluble binder or water soluble suspension comprising at least one of grip enhancing media, flavor, medicament, sweetener, color, analgesic, coagulant, tartar controlling agent, anti-caries agent or antiseptic.

In a further embodiment where the primary floss structure is porous, the present invention also includes the step of filling the surface of the primary floss structure with other materials. Filler particles can be applied to the surface of the primary floss structure. This process is referred to as surface filling, as distinguished, from conventional means of filling pores, for example of porous ePTFE articles, which may include such techniques as blending or co-coagulation of the filler material with PTFE, impregnating the pores with filler, and altering the surface then bonding other materials to that surface.

The inventive processes of the present invention described herein can be applied to a vast array of types and shapes of articles including, but not limited to, tubes, fibers, including but not limited to twisted, round, flat and towed fibers, membranes, tapes, sheets, rods, and the like, each possessing any of a variety of cross-sectional shapes.

The present invention is useful when incorporated into dental floss appliances such as floss picks both static and dynamic, electro-mechanical actuated floss brushes/picks and static floss holders. The minimal loss of drag resistance of the present invention maintains the floss' ability to remove plaque.

The present invention will be further described with respect to the non-limiting Examples provided below.

### Test Methods

### Drag Resistance Test

Dynamic drag resistance was determined using a fixture 180 as shown in FIG. 2 using three 12.7 mm (0.50 inch) diameter cylindrical shafts mounted on a rigid beam which was cantilevered from a standard tensile tester, Model 5567 from INSTRON Company (Canton, Mass.). The fixture arm support 176 was drilled and reamed nominal 12.7 mm diameter (nominal 0.500 inch diameter) for a running fit of three cylinders 170, 172 and 174 (available from McMaster-Carr Supply Company, Dayton, N.J., Part Number 8546K13, Virgin, electrical grade TEFLON® nominal 12.7 mm diameter, and parted off at nominal lengths of 25 mm) in the fixture arm support, which were secured using set-screws compressing radially on the cylinders at the cylinder-support interface. The cylinders were secured such that they did not rotate during a test iteration and extended out of the test fixture approximately 17 mm. All three cylinders were parallel which each other and perpendicular with the cantilever fixture arm support 176.

Before each sample was tested, the cylinders were removed from the fixture, completely submerged in a beaker containing 99.9% isopropanol alcohol for 1 minute, replaced in the test fixture and permitted to air dry completely.

The INSTRON 5567 tensile tester was outfitted with a one yarn style clamping jaw suitable for securing filament samples during the measurement in the mode of tensile loading. The jaw was connected to a 100 Newton rated load cell (not shown) which was secured on the tester's cross-head. The cross-head speed of the tensile tester was 50.8 mm per minute, and the gauge length was 50 mm (measured from the tangent point of the yarn clamp down to the tangent point of the test specimen resting against the first of the three cylinders 170). The fixture 176 was secured to the tensile tester such that the test specimen secured in the clamping jaw was perpendicular to the axis of cylinder 170.

The test article was threaded around the three cylinders 170, 172 and 174 in the manner depicted in FIG. 2. Consequently, the sample was wrapped halfway around cylinder 170 and a quarter of the way around cylinders 172 and 174. Hence, a total cumulative wrap angle of one full wrap (i.e., 2π radians) was achieved.

The vertical distance between the center points of cylinders 170 and 172 tangent points was 25.4 mm. The horizontal distance between the center points of the same two cylinders was 12.7 mm. The horizontal distance between the center points of cylinders 172 and 174 was 360.4 mm.

Since the inventive material may be produced to provide islands on only one side of the material, the samples were all twisted so that the same side contacted the surface of all three cylinders. This results in placing a one turn twist in all test specimens between cylinders 170 and 172. The test specimens had no twist between cylinders 172 and 174. A 50 gram weight 186 was fixed to the end of the test specimen. The length of the test specimen extending past cylinder 174 and down to the suspended 50 gram weight 186 was at least 110 mm, but no more than 510 mm.

In order to determine drag resistance of samples, five samples long enough to conduct the test were randomly selected and tested. To begin the test, the tensile tester cross-head was set to move upwards, thus causing the 50 gram weight to move upwards as well. The test specimen slid over the three cylinders for at least a travel length of 80 mm, but no more than 510 mm. The load cell was connected to a data acquisition system such that the load induced as the test specimen slid over the cylinders during the upward motion of the cross-head was recorded at a rate of at least 10 data points per second. The data acquisition system recorded the corresponding cross-head displacement during the testing as well. The drag resistance at each cross-head displacement was then calculated by the following formula:

e^{(δθ)}=T₂/T₁, which reduces to: δ=[ln(T₂/T₁)]/θ,

where:
δ=Drag Resistance
θ=Cumulative Wrap Angle in Radians=2π radians
T₁=average input tension=50 grams
T₂=average output tension as recorded by data acquisition in gram force
(Note: in is the Natural Logarithm Base on E=2.71828)

Data were obtained for displacements between 0 mm to 76 mm. The dynamic drag resistance was determined by using the arithmetic mean-calculated drag resistance over the displacement between 10 to 20 mm.

### Multiple Pass—Decay of Drag Resistance Test

The decay of dynamic drag resistance was determined using a fixture 180 as shown in FIG. 2 using three 12.7 mm (0.50 inch) diameter cylindrical shafts mounted on a rigid beam which was cantilevered from a standard tensile tester, Model 5567 from INSTRON Company (Canton, Mass.). The fixture arm support 176 was drilled and reamed nominal 12.7 mm diameter (nominal 0.500 inch diameter) for a running fit of three cylinders 170, 172 and 174 (available from McMaster-Carr Supply Company, Dayton, N.J., Part Number 8546K13, Virgin, electrical grade TEFLON® nominal 12.7 mm diameter, and parted off at nominal lengths of 25 mm) in the fixture arm support, which were secured using set-screws compressing radially on the cylinders at the cylinder-support interface. The cylinders were secured such that they did not rotate during a test iteration and extended out of the test fixture approximately 17 mm. All three cylinders were parallel which each other and perpendicular with the cantilever fixture arm support 176.

Before each sample was tested, the cylinders were removed from the fixture, completely submerged in a beaker containing 99.9% isopropanol alcohol for 1 minute, replaced in the test fixture and permitted to air dry completely.

The INSTRON 5567 tensile tester was outfitted with a one yarn style clamping jaw suitable for securing filament samples during the measurement in the mode of tensile loading. The jaw was connected to a 100 Newton rated load cell (not shown) which was secured on the tester's cross-head. The cross-head speed of the tensile tester was 50.8 mm per minute, and the gauge length was 50 mm (measured from the tangent point of the yarn clamp down to the tangent point of the test specimen resting against the first of the three cylinders 170). The fixture 176 was secured to the tensile tester such that the test specimen secured in the clamping jaw was perpendicular to the axis of cylinder 170.

The test article was threaded around the three cylinders 170, 172 and 174 in the manner depicted in FIG. 2. Consequently, the sample was wrapped halfway around cylinder 170 and a quarter of the way around cylinders 172 and 174. Hence, a total cumulative wrap angle of one full wrap (i.e., 2π radians) was achieved.

The vertical distance between the center points of cylinders 170 and 172 tangent points was 25.4 mm. The horizontal distance between the center points of the same two cylinders was 12.7 mm. The horizontal distance between the center points of cylinders 172 and 174 was 360.4 mm.

Since the inventive material may be produced to provide islands on only one side of the material as well as comparative floss having only one side coated with wax, the samples were all twisted so that the same side contacted the surface of all three cylinders, namely the coated side for the wax coated materials and the island side for the present invention. This results in placing a one turn twist in all test specimens between cylinders 170 and 172. The test specimens had no twist between cylinders 172 and 174. A 50 gram weight 186 was fixed to the end of the test specimen. The length of the test specimen extending past cylinder 174 and down to the suspended 50 gram weight 186 was at least 110 mm, but no more than 510 mm.

The decay to drag resistance was determined in the following manner. A test sample floss was randomly selected. The side of the floss that was either coated or contained the island was visually identified and placed in the drag fixture as described above. To begin the test, the tensile tester cross-head was set to move upwards, thus causing the 50 gram weight to move upwards as well. The test specimen slid over the three cylinders for at least a travel length of 80 mm, but no more than 110 mm for a first pass. Then the tensile tester was returned to its original starting position at a rate of 254 mm per minute. The second pass then was immediately started at a rate of 50.8 mm per minute using a similar stopping point as pass 1. This iteration continued until 5 passes where completed, namely five up strokes at 50.8 mm per minute and four down strokes at 254 mm per minute. The load cell was connected to a data acquisition system such that the load induced as the test specimen slid over the cylinders during the upward motion of the cross-head was recorded at a rate of at least 10 data points per second. Only the drag resistant in the up stroke was recorded. The data acquisition system recorded the corresponding cross-head displacement during the testing as well. The drag resistance at each cross-head displacement was then calculated by the following formula:

$${e}^{δθ} = \frac{{T}_{2}}{{T}_{1}}$$

which reduces to:

$$δ = \frac{ln ( \frac{{T}_{2}}{{T}_{1}} )}{θ}$$

where:

δ=Drag Resistance

θ=Cumulative Wrap Angle in Radians=2π radians

T₁=average input tension=50 grams

T₂=average output tension as recorded by data acquisition in gram force

(Note: in is the Natural Logarithm Base on E=2.71828)

Data were obtained for displacements between 0 mm to 76 mm. The dynamic drag resistance was determined by using the arithmetic mean-calculated drag resistance over the displacement between 10 to 15 mm.

The delta decay drag resistance was computed using the following formula:

$$Δ DecayDrag = ( {δ}_{avg 1} - {δ}_{avg N} ) \times \frac{100}{{δ}_{avg 1}}$$

where

δ_{avg 1}=Average Drag Resistance Pass I

δ_{avg N}=Average Drag Resistance Pass_{N}, where N=passes 1 through 5

### Island Height and Spacing Measurement

Island height and spacing was measured using Zygo Optical Profilometry (Zygo Corporation, Middlefield, Conn.). The Zygo New View 5032 Optical Profilometer was set up with the following parameters, using the 50× objective (0.64 μm lateral resolution), 0.8× zoom, minimum modulation necessary for a valid data point=2% and Minimum Area Size=7. Piston background was subtracted prior to topography analysis. Data was compiled using the advanced texture application of the Zygo New View program. Each peak in the area scanned was measured for the height and peak to valley data recorded in the summary table.

The height parameter is the height or the roughness between two predefined reference lines. The computer generates two reference lines. The upper reference line exposes below the top 5% of the data, and the lower reference line exposes 90% of the data. Thus, 85% of computer identified peaks were calculated for height. The Peak to Valley parameter is the height between the lowest and highest point on the test part surface. The Peak spacing data is the average distance between peaks for the total area scanned between the two reference lines.

### Dimensional Measurements

Thickness was measured between the two plates of a Mitutoyo/MAC micrometer, unless indicated otherwise. Three different sections were measured on each sample. The average of the three measurements was used.

Width was measured using a digital caliper. The average of the three measurements was used.

### EXAMPLES

In order to demonstrate the unique surfaces of the materials of the present invention as compared to the surface of a primary floss structure of an untreated floss, surface scanning electron micrographs were taken. Higher and lower magnification images were taken in the same regions for most samples. Samples were thoroughly scanned to ensure that the images were representative of the sample.

### Example 1

A structure was prepared comprising FEP on polyimide mono filament floss.

A floss material was provided which was made from 0.002″ thick polyimide sheet material available from McMaster-Carr Supply Company, Dayton, N.J., under the trademark KAPTON® of the DuPont Company. Sheet material (part number 2271K2, translucent amber color) was cut into a widths of about 1.5 mm and cut into sections about 500 cm in length. NEOFLON NP-12×FEP powder available from Daikin (Orangeburg, New York) was uniformly dispensed on one side of the floss increasing the floss weight by about 4 to 5%. The FEP powder was dispensed using a 50 mesh (297 μm) sieve.

The coated floss was placed in a force air convection oven at about 295° C. for 2 minutes and then removed and place in ambient conditions. The resulting floss appeared to have a rough tactile characteristic. Sections of the floss were cut from the 500 cm length element and analyzed using SEM. FIGS. 4, 5, and 6 (about 20×, 450×, and about 20× magnification respectively) show the random, non-patterned array of island formation created on the polyimide surface. The FEP islands appear to be melt bonded to the polyimide monofilament as evidenced by minimal degradation to the drag resistance after repeated passes on the test fixture. Since the particles were bonded to floss's surface the likelihood for the FEP to be removed from the floss during use is greatly minimized.

Island height and spacing was measured by the test described above for two samples, at three areas per sample, and the results are as follows.

| | Area | Height | Peak to | Peak Spacing |
|---|---|---|---|---|
| Sample Type | Scanned | μm | Valley μm | μm |
| FEP/polyimide - | 1 | 12.527 | 12.04 | 13.729 |
| Sampel 1 | | 9.592 | 9.38 | |
| | 2 | 8.893 | 8.82 | 14.16 |
| | | 7.15 | 7.02 | |
| | | 7.125 | 6.69 | |
| | | 12.333 | 12.1 | |
| | | 5.626 | 5.1 | |
| | | 6.543 | 5.94 | |
| | | 6.185 | 5.07 | |
| | 3 | 6.721 | 6.27 | 13.11 |
| | | 9.094 | 6.81 | |
| | | 13.445 | 13.32 | |
| | | 7.081 | 6.52 | |
| | | 7.885 | 7.57 | |
| | | 4.572 | 0.15 | |
| FEP/polyimide - | 1 | 16.849 | 16.84 | 15.349 |
| Sample 2 | | 37.292 | 36.99 | |
| | | 8.929 | 6.3 | |
| | | 7.174 | 6.92 | |
| | | 21.117 | 21.07 | |
| | 2 | 7.402 | 7.05 | 14.2 |
| | | 16.196 | 16.18 | |
| | | 5.753 | 5.12 | |
| | | 3.823 | 3.66 | |
| | 3 | 8.585 | 8.01 | 12.177 |
| | | 13.344 | 13.28 | |
| | | 11.036 | 10.95 | |

### Example 2

A structure was prepared comprising FEP on ePTFE and tested as follows.

An ePTFE floss material made in accordance to U.S. Pat. No. 5,518,021 was cut into a section 500 cm in length. FEP powder NEOFLON NP-12X available from Daikin (Orangeburg, New York) was uniformly dispensed on one side of the floss increasing the floss weight by about 4 to 5%. The FEP powder was dispensed using a 50 mesh (297 μm) sieve.

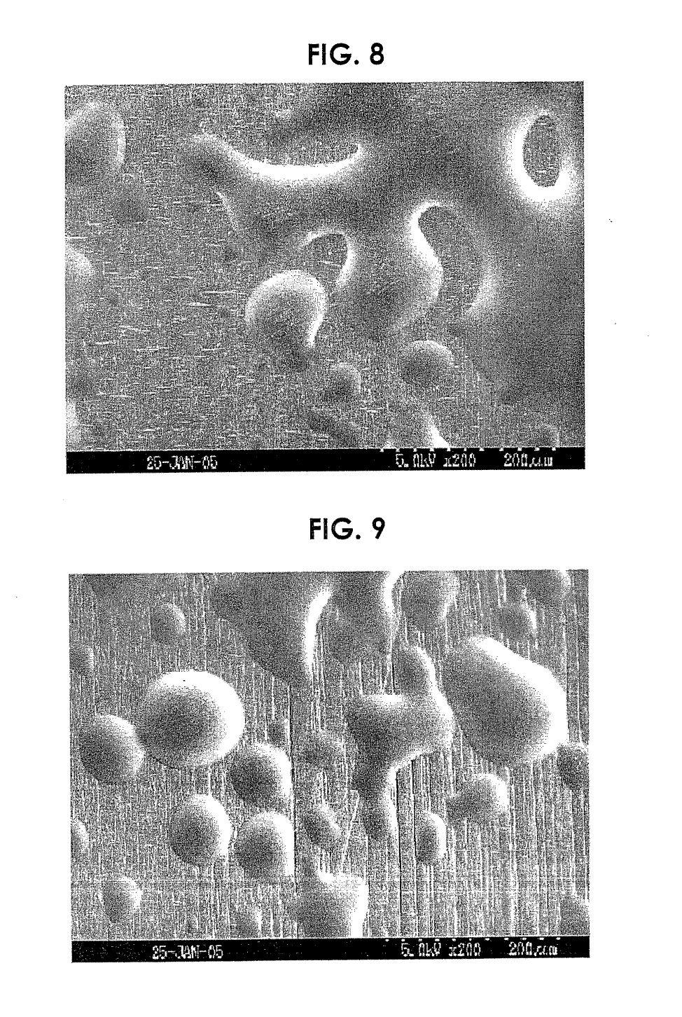

The coated floss was placed in a force air convection oven at about 295° C. for about 60 minutes and then removed and place in ambient conditions. The resulting floss appeared to have a rough tactile characteristic. Sections of the floss were cut from the 500 cm length and analyzed using SEM. FIGS. 8-10 (approximately 10×, 200×, 200×, and 10× magnification respectively) show the random, non-patterned formation of islands created on the ePTFE surface, compared to the surface of ePTFE untreated with FEP (FIG. 3). The FEP islands appear to be bonded to the ePTFE monofilament which minimizes the likelihood for the FEP to be removed from the floss during use.

### Example 3

A surface modified UHMWPE powder available from Fluoro-Seal International, LP., located in Houston, Tex., was dispersed in de-ionized water and a surfactant Dynol 604 from Air Products. The surfactant was at about 1% by volume water, and the UHMWPE was added to yield a solid to liquid ratio of about 5% w/w. The UHMWPE-H₂O dispersion was brushed on the surface of cut strips, 2 mm wide of UHMWPE 0.003″ thick sheet material available from McMaster-Carr Supply Company, Dayton, N.J. The brush was a standard “acid” brush having approximately a 1 cm wide bristle tuft.

Sample 1 was coated using a single brush stroke is a fast hand movement manner. Sample 2 was coated with a single brush stroke using a slow hand motion. The coated UHMWPE strips were placed in a forced-air convection oven at a temperature of about 170° C. for a period of about 5 minutes. The UHMWPE particles adhered to the UHMWPE substrate and formed islands. The resulting structure possesses a rough tactile characteristic. The table below describes the weight pick-up after drying.

| | Uncoat Weight | | Dried Coated | Percent Coat |
|---|---|---|---|---|
| Sample # | (g) | Brush Speed | Floss (g) | Weight |
| 1 | 0.0456 | Fast | 0.0482 | 5.7% |
| 2 | 0.0453 | slow | 0.0501 | 10.6% |

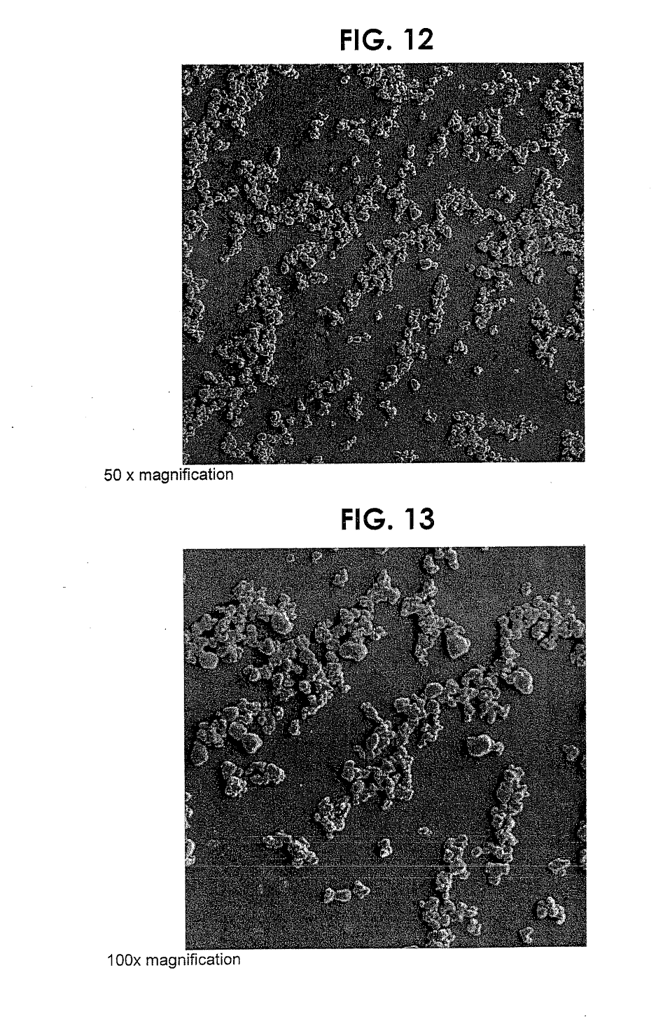

FIG. 11 is a micrograph of Sample 2 according to Example 3 at 20× magnification, having a heavy coating of UHMWPE on a UHMWPE substrate. FIGS. 12 and 13 are micrographs of Sample 2 of Example 3 at 50× and 100× magnification, respectively.

### Example 4

A structure was prepared comprising UHMWPE islands on UHMWPE monofilament.

UHMWPE powder was uniformly sprinkled on 30 mm wide by 1000 mm long strips of UHMWPE film, 0.003″ thick available form McMaster Carr, Company. The powder is about 6,000,000 average molecular weight and was originally available from Hoechst (now Ticona), part number GUR® 4150. The applied powder was equal to about 10-15% of the weight of film. The coated film was heated to about 160° C. for 10 minutes in a forced air convection oven. The material was removed from the oven and allowed to cool to ambient temperature. The cooled material was then cut into strips 2-3 mm wide. Sections of the floss were cut from the 500 cm length element and analyzed using SEM. FIG. 14 is a SEM at a magnification of 50× of topical view of the inventive floss. FIG. 15 is a topical view at 200× of the inventive floss. The average drag resistance of the inventive material was about 0.101, standard deviation 0.008, N=236 and average drag resistance demonstrated by a primary polymer structure without surface modification, meaning without the UHMWPE powder was about 0.0842 standard deviation 0.0078, N=118. Performing a Student T test, at a 95% confidence interval, the inventive material was shown to be statistically different over the control smooth material for increased drag resistance.

Island height and spacing was measured according to the method described in the test methods section; the results are as follows.

| Sample | Area | Height | Peak to | Peak Spacing |
|---|---|---|---|---|
| Type | Scanned | μm | Valley μm | μm |
| UHMWPE | 1 | 74.43 | 74.758 | 14.504 |
| | | 53.843 | 53.61 | |
| | | 45.981 | 45.72 | |
| | 2 | 27.406 | 26.92 | 14.803 |
| | | 28.342 | 27.5 | |
| | 3 | 39.542 | 39.21 | 11.93 |
| | | 62.995 | 62.48 | |
| | | 48.985 | 48.66 | |

Data from the Decay of Drag Resistance (ΔDecayDrag)

Using the test method for determining the delta decay of drag resistant, the inventive article from Example 4 was compared to the original GLIDE® Floss commercially available from the Procter & Gamble Company, Cincinnati, Ohio. Two samples of wax coated GLIDE Floss and two samples of Example 4 were tested for determining decay of drag resistance. The results follow:

Delta Decay of Drag Resistance

| | Comparative | Comparative | Example 4 | Example 4 |
|---|---|---|---|---|
| Pass 1 | 0 | 0 | 0 | 0 |
| Pass 2 | 20 | 11 | 8 | 11 |
| Pass 3 | 39 | 21 | 13 | 20 |
| Pass 4 | 55 | 28 | 15 | 25 |
| Pass 5 | 55 | 33 | 16 | 25 |

| | | |
|---|---|---|
| Average | 44 | 20.5 |

The data indicate that there does not exist more than a 16-25%, or an average of 20.5%, in the decay of drag resistance after five repeated passes of the inventive floss compared to a 33-55%, or an average of 44%, decay in the drag resistance of a typical wax coated dental floss after five repeated passes. Maintaining drag resistance during flossing maintains the cleaning efficacy of the floss during use.

While the invention has been disclosed herein, in connection with certain embodiments and detailed descriptions, it will be clear to one skilled in the art that modifications or variations of such detail can be made without deviating from the gist of the invention and such modifications or variations are considered to be within the scope of the claims herein below.

We claim:

1. A dental floss comprising:
a primary structure in the form of a floss comprising a first polymer material, and
islands of a second polymer material on the surface of the primary structure,
wherein the dental floss has a drag resistance decay of less than about 30%.

2. The dental floss of claim 1 wherein the islands additionally penetrate a portion of the primary structure.

3. The dental floss of claim 1 wherein the dental floss has a drag resistance decay of less than about 25%.

4. The dental floss of claim 1 wherein the dental floss has a drag resistance decay of less than about 20%.

5. The dental floss of claim 1 wherein the primary structure is unfilled.

6. The dental floss of claim 1 wherein the first polymer material comprises polyimide.

7. The dental floss of claim 1 wherein the first polymer material comprises polyamide.

8. The dental floss of claim 1 wherein the first polymer material comprises expanded polytetrafluoroethylene (ePTFE).

9. The dental floss of claim 1 wherein the first polymer material comprises ultra high molecular weight polyethylene (UHMWPE).

10. The dental floss of claim 1 wherein the second polymer material comprises polyethylene (PE).

11. The dental floss of claim 1 wherein the second polymer material comprises polyamide.

12. The dental floss of claim 1 wherein the second polymer material comprises UHMWPE.

13. The dental floss of claim 1 wherein the second polymer material comprises fluorinated ethylene-propylene (FEP).

14. The dental floss of claim 1 wherein the first and second polymer materials are the same.

15. The dental floss of claim 1 wherein the first and second polymer materials are different.

16. The dental floss of claim 1 wherein the islands are attached to the surface of the primary structure.

17. The dental floss of claim 1 wherein the islands are oriented on the primary structure in a patterned configuration.

18. The dental floss of claim 1 wherein the islands are on the primary structure in a non-patterned configuration.

19. The dental floss of claim 1 wherein the islands have peaks having a height.

20. The dental floss of claim 19 wherein about 85% of the island peaks have a height between about 5 μm and 100 μm.

21. The dental floss of claim 19 wherein about 85% of the island peaks have a height between about 5 μm and 80 μm.

22. The dental floss of claim 19 wherein about 85% of the island peaks have a height between about 10 μm and 37 μm.

23. The dental floss of claim 1 wherein the islands have a space between the islands.

24. The dental floss of claim 23 wherein the islands have an average spacing of less than about 250 μm.

25. The dental floss of claim 23 wherein the islands have an average spacing of less than about 75 μm.

26. The dental floss of claim 1, wherein the dental floss is used in a dental device.

27. A process for forming a dental floss having enhanced grippability comprising:
providing a primary structure in the form of a floss comprising a first polymer,
providing a second polymer on a surface of the primary structure, and
heating the fiber or tape having the second polymer to above the melt temperature of the second polymer to form islands attached to the surface of the primary structure.

28. The process of claim 27, wherein the second polymer is provided to the surface of the primary structure in the form of a powder.

29. The process of claim 27 wherein the second polymer is provided to the surface of the primary structure in the form of a coating.

30. The process of claim 27 wherein the second polymer is provided to the surface of the primary structure in the form of a dispersion.

31. The process of claim 27 where in the first polymer comprises polyimide.

32. The process of claim 27 where in the first polymer comprises ePTFE.

33. The process of claim 27 where in the first polymer comprises UHMWPE.

34. The process of claim 27 where in the second polymer comprises FEP.

35. The process of claim 27 where in the second polymer comprises UHMWPE.

36. The process of claim 27 where in the second polymer comprises PE.

37. A dental floss comprising:
a primary structure in the form of a floss comprising ePTFE, and
islands of FEP on the surface of the primary structure.

38. The dental floss of claim 37 wherein a portion of the islands penetration a portion of the primary structure.

39. The dental floss of claim 37 wherein the dental floss has a decay of drag resistance of less than about 30%.

40. The dental floss of claim 37 wherein the dental floss has a decay of drag resistance of less than about 25%.

41. The dental floss of claim 1, wherein the dental floss has a denier of about 500 to 3000 grams per 9000 meters.

42. The dental floss of claim 1, wherein the dental floss is a monofilament fiber.

43. The dental floss of claim 42 comprising a plurality of monofilament fibers combined in a twisted configuration.

44. The dental floss of claim 1 further comprising a water soluble coating.

45. The dental floss of claim 1 further comprising one or more of flavorant, color, flavor enhancer, sweetener, natural wax, synthetic wax, hydrocarbon based wax, micro crystalline wax, beeswax, medicament, abrasive, grip enhancing media, tartar control agent, anti caries agent, enzyme, vitamin, bio-active agents, recalcification agents, micro-sphere, coagulant and analgesic.
